(19) United States
(12) Patent Application Publication
(10) Pub. No.: US 2014/0169665 A1
(43) Pub. Date: Jun. 19, 2014

(54) Automated Processing of Documents

(71) Applicant: Porta Holding Ltd., Tortola (VG)

(72) Inventors: Rasmus Berg Palm, Copenhagen (DK); Claus Thrane, Aalborg (DK); Gert Sylvest, Copenhagen (DK); Mikkel Hippe Brun, Gentofte (DK)

(73) Assignee: Porta Holding Ltd., Tortola (VG)

(21) Appl. No.: 14/186,876

(22) Filed: Feb. 21, 2014

Related U.S. Application Data
(63) Continuation of application No. 13/785,933, filed on Mar. 5, 2013.

(30) Foreign Application Priority Data
Mar. 5, 2012 (GB) 1203858.4

(51) Int. Cl. G06K 9/66; G06K 9/62

(52) U.S. Cl. CPC G06K 9/66; G06K 9/6267
USPC 382/161

(57) ABSTRACT

A system and method for processing documents with automatic improvements to the processing. Documents are submitted to a processing system and data is extracted from the documents. The data may be extracted utilising OCR techniques. The data may be verified and interpreted utilising classifiers and predefined feature extraction rules which may improve their performance through an iterative learning cycle.

### TECHNICAL FIELD

The present invention relates to a system and method for the automation of document processing. It is particularly related to, but in no way limited to, the automation of invoice processing.

### BACKGROUND

Electronic invoicing from suppliers to customers is appealing as it has the capability to reduce the overhead of invoicing and securing payment, thereby providing a more efficient invoicing system for suppliers and customers alike.

Existing electronic invoice management systems, while providing efficiency improvements, are often complex and costly to set up as they require suppliers and customers to implement an agreed electronic system for invoicing. This requires either subscription to external service providers, or the production of a customized invoicing system.

A partial implementation of electronic invoicing utilizes electronic transmission of documents by attachment to an email or other electronic communication means. This approach removes the need for suppliers and customers to subscribe to a common invoice management system and improves speed of communication, but does not improve the handling and management of invoices

The embodiments described below are not limited to implementations which solve any or all of the disadvantages of known invoice management systems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A system and method for processing documents is described. Documents are submitted to a processing system and data is extracted from the documents. The data may be extracted utilising OCR techniques. The data may be verified and interpreted utilising profiles and predefined interpretation rules which may improve their performance through an iterative learning cycle.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc and do not include propagated signals. The software can be suitable for execution on a parallel processor or a serial processor such that the method steps may be carried out in any suitable order, or simultaneously.

This acknowledges that firmware and software can be valuable, separately tradable commodities. It is intended to encompass software, which runs on or controls “dumb” or standard hardware (e.g. a general purpose computer), to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a flow diagram that provides an overview of an example system according to the current disclosure;

FIGS. 2 and 3 show sequence diagrams for transmission and processing of documents;

FIG. 4 shows a schematic diagram of a computer system on which the current system may be implemented; and

FIGS. 5-7 show exemplary screen shots of a web interface for implementing the methods described herein.

Common reference numerals are used throughout the figures to indicate similar features.

### DETAILED DESCRIPTION

Embodiments of the present invention are described below by way of example only. These examples represent the exemplary ways of putting the invention into practice that are currently known to the Applicant although they are not the only ways in which this could be achieved. The description sets forth the functions of the example and the sequence of steps for constructing and operating the example. It is contemplated, however, the same or equivalent functions and sequences may be accomplished by different examples. For example, although the invention is described in terms of an invoice being provided by a supplier to a customer, it has broader application to other types of documents between a sender and a receiver that may benefit from electronic processing.

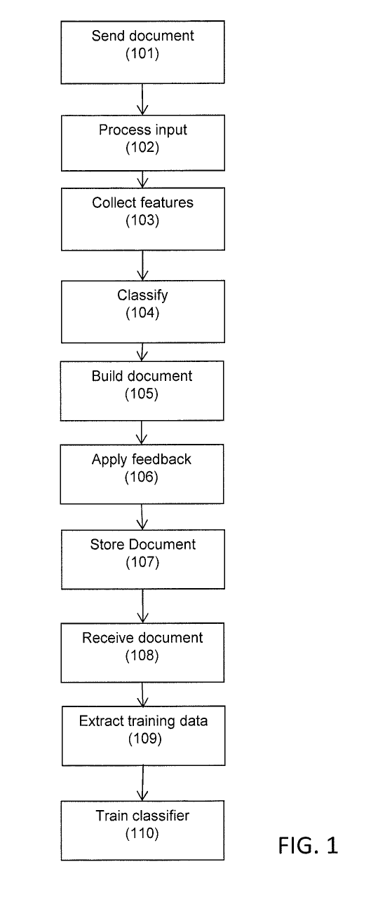

FIG. 1 is a flow-chart diagram that shows a schematic overview of a system according to the current disclosure. At block 101 a sender, e.g. a supplier, creates a document, e.g. an invoice for services rendered, and outputs it as an electronic semi-structured or unstructured document. For example a pdf or image file may be created based on data in an accounting system, spreadsheet or other such data source. The document may be emailed or otherwise transmitted to a processing system assigned by a receiver, e.g. a customer. For example, the document may be transmitted to a computer system providing processing services on behalf of the customer. At block 102 the document is processed by the processing system to analyse its contents. In particular the system may perform an Optical Character Recognition (OCR) process to identify areas of text in an image document and convert them from the received semi-structured or unstructured format received to machine readable characters and positional and area information, for example ASCII characters and document-relative coordinates for a bounding area. Alternatively the processing may extract machine-readable text from the file if that is appropriate for the file type; for example, character information extracted from a pdf file.

At block 103 the scanned data is fed into a feature collector which collects N features for each area. A feature may include, for example, a description of the relationship between the feature and the area, e.g. ‘text length’ is 7, ‘x coordinate’ is 42.9, ‘y coordinate’ is 33.8, ‘Levenshtein distance from a special word’ is 2, ‘percentage of line whitespace’ is 59.1, and may also include features derived from previously received documents such as features based on the position of previously recognized elements on documents from the sender to that receiver.

At block 104 the classifier uses the extracted machine-readable data to match the data to expected semantically defined data fields (“canonical fields”) and the data stored in a database. At block 105 the result of that classification is embodied into a document called the ‘draft’.

At block 106 an electronic communication is created to the sender requesting verification of the data extracted from the electronic invoice. The communication may present the original invoice alongside the extracted data to ensure the system has performed correctly. In return the sender provides corrections to the data and the classification, and the corrections are applied to the classifier.

At block 107 the invoice is saved into the invoicing system for acceptance and at block 108 that document is forwarded to and received by the receiver. At block 109, data may be extracted from data stored in block 107 for further training of the classifier in block 110.

The system outlined in FIG. 1 thereby provides a method for suppliers to provide invoices or other documents in a structured format to a customer via electronic communications means without the need to re-enter those details into an invoicing system. This process is superior to traditional means of invoice processing where the burden of scanning, OCR and error correction is handled by the customer. Simultaneously it saves the time for suppliers that they typically type in all information manually, instead relying on the data already output by the senders electronic invoice generating system (such as for example an accounting system). The system utilises a feedback mechanism to allow a supplier to verify and correct any mistakes made by the automated processing system.

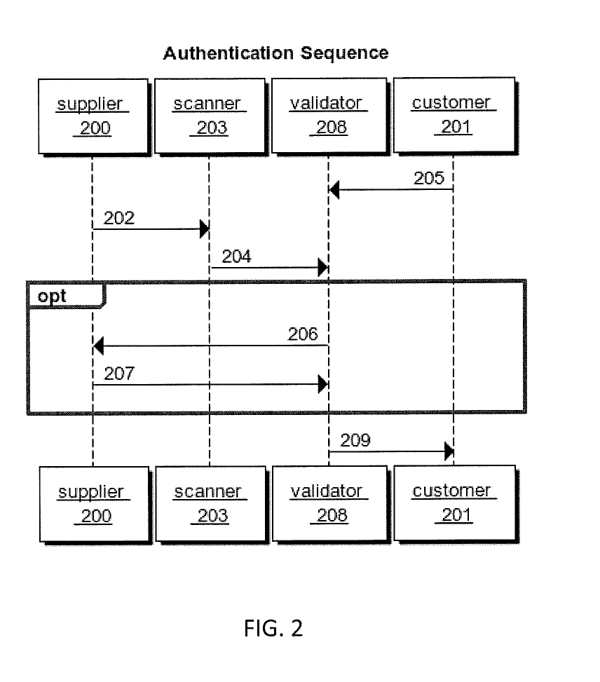

FIG. 2 shows a sequence diagram of a system for electronically transmitting documents. A supplier 200 wishes to transmit a rendered document, for example an invoice, comprising semi-structured or unstructured data to a customer 201 for processing. At 202 the sender 200 transmits the document to a defined scanner system 203. For example, the customer 201 may request the supplier to send all invoices to an email address of invoices@customer.com. This email address is configured to be accessed by the scanner system 203. The scanner system 203 performs the processing as outlined hereinbefore by extracting information from the semi-structured or unstructured document and converting it to machine readable form. At 204 the scanner system forwards the extracted data to a validator system 208 which analyses the extracted data and compares it to defined validation rules. For example, the validator 208 may compare names and addresses to expected suppliers, or may verify that only numerical values appear where numbers are expected, or that line totals adds up to the invoice total. The customer 201 may have predefined a set of validation rules at 205 which are associated with documents transmitted to their address, or a set of standard rules may be utilised.

If the document does not pass the validation rules, at 206 a message may be returned to the supplier highlighting the failures and requesting the supplier make any corrections needed. At 207 the supplier attends to the corrections and re-submits the document. This process may be iterated until all failures are corrected. It may also be possible for a supplier to ignore or bypass certain failures if they are not applicable in some cases.

At 209 the validator transmits a communication to the customer indicating that a document has been processed and is available. For example, the output of the processing may be inserted into an accounting system for further viewing and processing by the customer. The communication to the customer may indicate what has occurred and the details of the document so that they can decide how to continue. For example, the customer may choose to save the data into the invoicing system for acceptance and ultimately payment by the customer.

The processes outlined in FIGS. 1 and 2 may be implemented in dedicated computer system or a cloud computing system utilising email and web-page interfaces for interaction with the users.

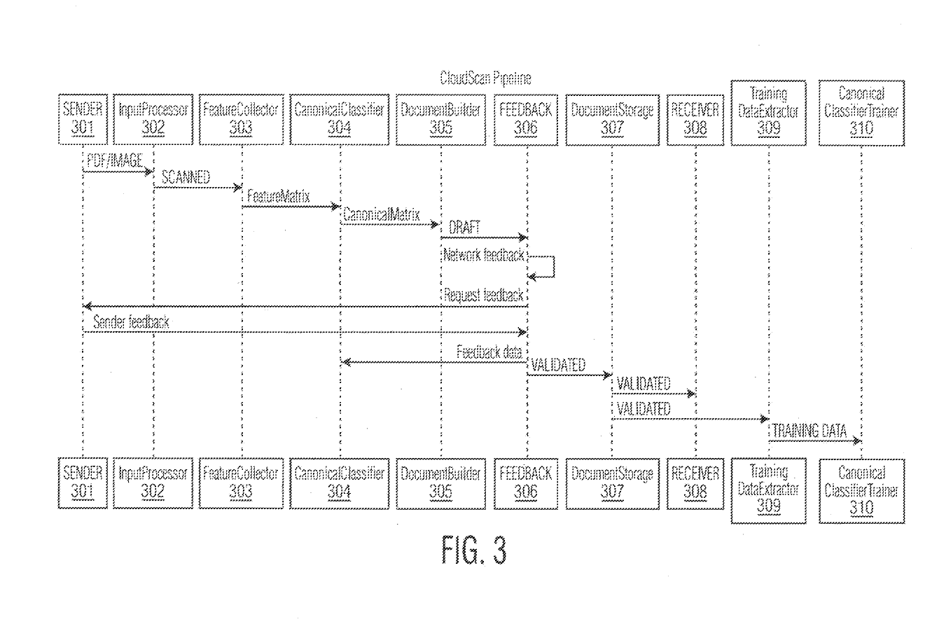

FIG. 3 shows a further sequence diagram showing an example of document processing. At step 301, an unstructured document representing business information such as an invoice, which may be formatted as a pdf, tiff or other image or machine-readable document, defined as the input document, is received from a sender. At step 302, the input document is processed using a number of computational steps, which may include OCR if the input document is an image document. The result is defined as the scanned document. The scanned document in step 302 consists of a collection of R areas containing recognized text. These areas might be, for example, individual words or clusters of such including lines, paragraphs, pages, generic areas etc.

At step 303, the scanned document is fed into a Feature Collector that collects N features for each area, using a number of Feature Extractors. Each Feature Extractor may facilitate computation of one or more features. For a given feature and area, a Feature Extractor may, for example, return a number describing a relationship between the feature and the area, e.g. ‘text length’ is 7, ‘x coordinate’ is 42.9, ‘y coordinate’ is 33.8, ‘Levenshtein distance from a special word’ is 2, ‘percentage of line whitespace’ is 59.1, etc. The Feature Extractors may reference features derived from previously received documents, e.g. features based on the respective positions of previously recognized elements on documents sent from the sender to the receiver. The features may also be other commonly observed patterns, e.g. the layout of the input document, ERP system, etc. The Feature Extractors may return features based on known data, such as sender master data, customer databases, etc. The output of the Feature Collector is an R×N matrix (associating the R areas to the N features), defined as the Feature Matrix which is fed into a Canonical Classifier at step 304.

The Canonical Classifier, at step 304, uses a classification algorithm (possibly based on Machine Learning) to classify each area by the probability of it being one of C Canonical fields. The output of the Canonical Classifier may be seen as a R×C matrix defined as the Canonical Matrix. The Canonical Classifier may, for example, build a frequency distribution for the Canonical fields based on the learning algorithm described below. Alternatively, it may use heuristics generated, for example, by an expert to generate Canonical fields to classify the areas.

At step 305 the Canonical Matrix is fed into a Document Builder. For each Canonical field the Document Builder takes the area with the highest value (probability) from the Canonical Matrix and assigns the content (text) within the area to the corresponding field in the document. The output of the Document Builder is a structured document identified as the Draft.

At step 306, the system provides real-time feedback to the Canonical Classifier, the feedback pertaining to the Draft may be obtained, for example, by querying in real time a network of associated businesses for contact and address information, dynamically updated product lists, and similar data that is updated in the network in real time. Alternatively or in addition, the feedback may be obtained by sending the Draft to the sender, who may corrects any remaining mistakes or, if the Draft is correct, validate the Draft. The corrections by the sender are feedback to the Canonical Classifier and are used by the Canonical Classifier at step 304 to revise the Draft. The validated Draft is identified as the Validated Document.

At step 307, the Validated Document is stored in a suitable store (e.g. a database in a volatile or non-volatile memory) with read/write access. The Validated Document is dispatched to the receiver in step 308.

At step 309 pairs of Canonicals and corresponding areas from the input document that were found to match are extracted from Validated Document and defined as training data to be added to a database of existing training data. This training data is added to the total set of all previously found training data, defined as Training Data Total. In step 310, the Training Data Total is used by the Canonical Classifier Trainer as additional feedback to improve the classification algorithm described with reference to step 306.

In the foregoing description, the sender, Input Processer, Feature Collector, Canonical Classifier, Document Builder, Feedback, Document Storage, receiver, Training Data Extractor and Canonical Classifier Trainer have been described separate processes and systems. However, this is only to aid in the description and understanding of the system and not as the required separation. As will be appreciated each of functions may be provided by one or more systems, and each system may provide one or more of the functions.

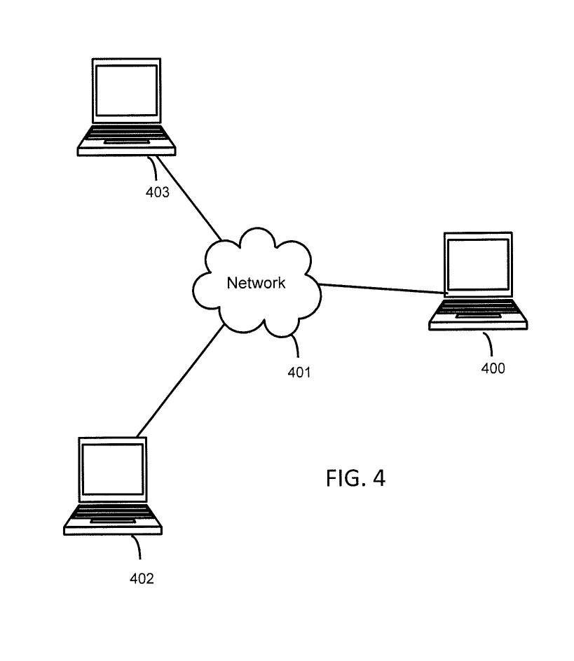

In an exemplary embodiment shown in schematic form in FIG. 4 the supplier 200, 301 may be a first computer system 400 controlled by the supplier connected to the Internet 401. The scanner, interpreter, and profile matching systems may be provided at a second computer system 402 controlled by the provider of the document processing system and connected to the Internet. Database systems for storing the output of the interpretation systems and provided further accounting and management functions may also be provided at system 402. The supplier may access the systems on computer system 402, for example, by sending emails to an address associated with that computer system, or via a web-interface provided by that system. The customer may be provided by a computer system 403 connected to the internet and controlled by the customer. The customer may access the systems on computer system 402, for example, via a web-interface provided by that system.

One of the functions of the system may comprise a store of frequently used data associated with certain documents. For example, names, addresses and account details may be stored which can be associated with a particular supplier, customer, or document type. The use of such pre-stored data may reduce the time needed to create and process documents, and improve the accuracy of the system rather than requiring the same data to be recreated each time it is required.

An aspect of the disclosure is the learning features of the interpretation and validation systems. These systems utilise the corrections and input by suppliers in response to the initial analysis of their documents to improve future performance.

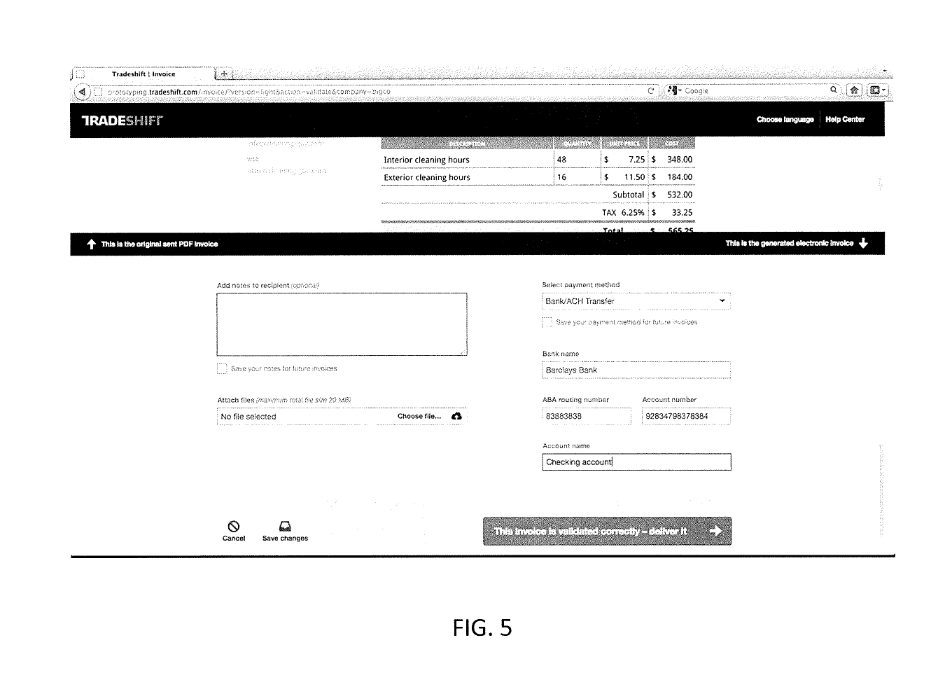

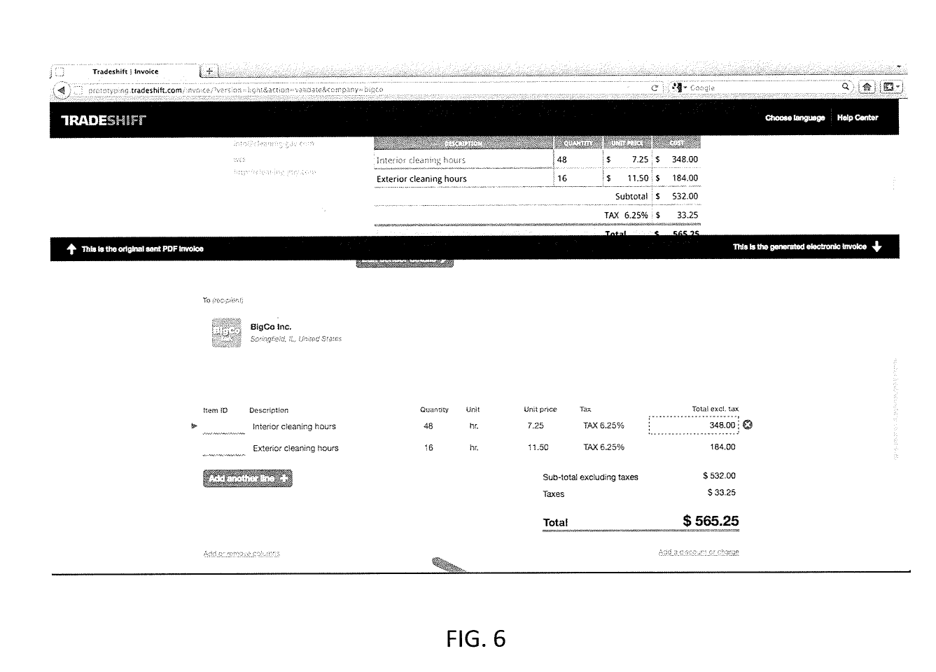

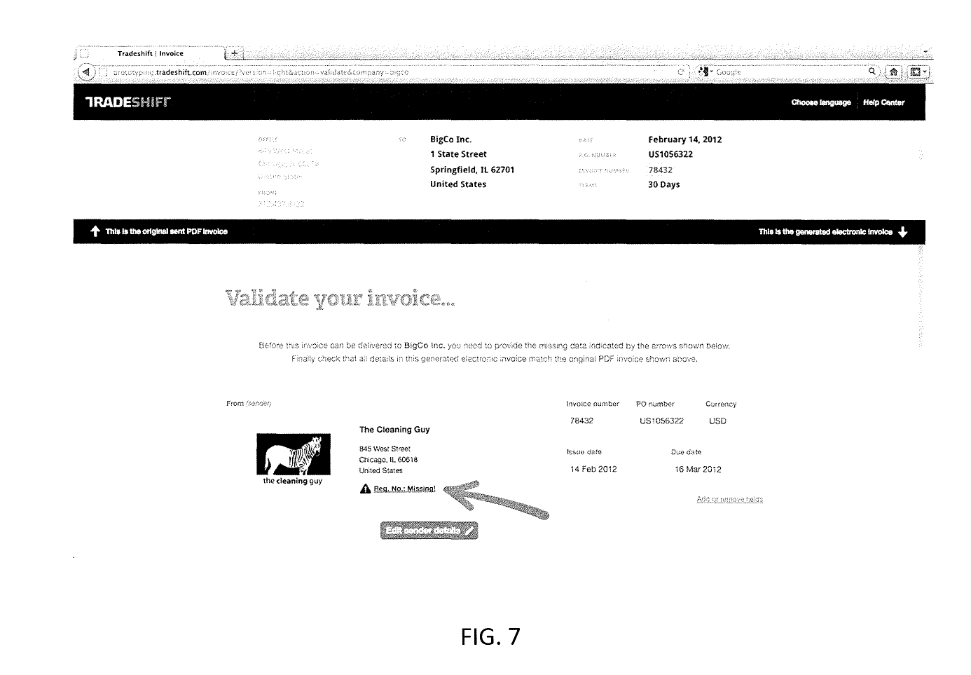

FIG. 5 shows a screen shot of a web-interface showing a submitted invoice in the upper half of the screen and the extracted data in the lower half of the screen to allow a supplier to compare their document to the data extracted from it. In FIG. 6 an area of the original document is highlighted as well as the corresponding entry in the extracted data, allowing easy comparison. In FIG. 7 an error with the extracted data is highlighted. By selecting the error, or a menu option, the supplier can correct for example an omission.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1-3. (canceled)

4. A computer-implemented method of processing electronic documents between a supplier and a customer, the method comprising:
receiving, by an intermediary system between a supplier and a customer, a particular electronic document from the supplier;
identifying, by the intermediary system, a plurality of areas within the first electronic document, each area including text;
computing a feature representing content within a particular area of the plurality of areas;
determining, by the intermediary system and based upon the feature representing content within the particular area, a label for the particular area from a set of labels that describe potential document areas;
generating, by the intermediary system, a draft that associates the determined label with the particular area and text extracted from the particular area; and
providing, by the intermediary system, the draft to the supplier for confirmation.

5. The method of claim 4, wherein determining a label for the particular area comprises:
generating a canonical matrix for one or more labels of the set of labels and one or more areas of the plurality of areas, including determining a probability that each area of the one or more areas corresponds to each label of the one or more labels; and
determining, for the particular area, a label of the one or more labels having a highest computed probability.

6. The method of claim 4, further comprising:
obtaining, from a network of businesses associated with the supplier, contact information for a particular contact; and
updating text associated with an area of the draft using the obtained contact information for the particular contact.

7. The method of claim 4, further comprising:
obtaining, from a network of businesses associated with the supplier, one or more product lists; and
updating text associated with an area of the draft using a particular product in the one or more product lists.

8. The method of claim 4, further comprising:
receiving, by the intermediary system, corrected text for the particular area;
generating a validated electronic document including associating the corrected text with the particular area; and
providing the validated electronic document to the customer.

9. The method of claim 8, further comprising:
updating a classifier including using the features for the particular area and the corrected text for the particular area received from the supplier as training data for the classifier.

10. The method of claim 4, wherein providing, by the intermediary system, the draft to the supplier for confirmation comprises:
generating a web interface from the draft, wherein the web interface presents an original version of the first electronic document in a first portion, and wherein the web interface presents one or more fields and text associated with each field in a second portion; and providing the web interface to the supplier.

11. The method of claim 10, further comprising receiving input of corrected text through the web interface.

12. The method of claim 10, wherein, based on user selection of a field of the one or more fields in the second portion of the web interface, the web interface highlights a corresponding area of the first electronic document in the first potion of the web interface.

13. A system comprising:
one or more computers and one or more storage devices storing instructions that are operable, when executed by the one or more computers, to cause the one or more computers to perform operations comprising:
receiving, by an intermediary system between a supplier and a customer, a particular electronic document from the supplier;
identifying, by the intermediary system, a plurality of areas within the first electronic document, each area including text;
computing a feature representing content within a particular area of the plurality of areas;
determining, by the intermediary system and based upon the feature representing content within the particular area, a label for the particular area from a set of labels that describe potential document areas;
generating, by the intermediary system, a draft that associates the determined label with the particular area and text extracted from the particular area; and
providing, by the intermediary system, the draft to the supplier for confirmation.

14. The system of claim 13, wherein determining a label for the particular area comprises:
generating a canonical matrix for one or more labels of the set of labels and one or more areas of the plurality of areas, including determining a probability that each area of the one or more areas corresponds to each label of the one or more labels; and
determining, for the particular area, a label of the one or more labels having a highest computed probability.

15. The system of claim 13, wherein the operations further comprise:
obtaining, from a network of businesses associated with the supplier, contact information for a particular contact; and
updating text associated with an area of the draft using the obtained contact information for the particular contact.

16. The system of claim 13, wherein the operations further comprise:
obtaining, from a network of businesses associated with the supplier, one or more product lists; and
updating text associated with an area of the draft using a particular product in the one or more product lists.

17. The system of claim 13, wherein the operations further comprise:
receiving, by the intermediary system, corrected text for the particular area;
generating a validated electronic document including associating the corrected text with the particular area; and
providing the validated electronic document to the customer.

18. The system of claim 17, wherein the operations further comprise:
updating a classifier including using the features for the particular area and the corrected text for the particular area received from the supplier as training data for the classifier.

19. The system of claim 13, wherein providing, by the intermediary system, the draft to the supplier for confirmation comprises:
generating a web interface from the draft, wherein the web interface presents an original version of the first electronic document in a first portion, and wherein the web interface presents one or more fields and text associated with each field in a second portion; and
providing the web interface to the supplier.

20. The system of claim 19, wherein the operations further comprise receiving input of corrected text through the web interface.

21. The system of claim 19, wherein, based on user selection of a field of the one or more fields in the second portion of the web interface, the web interface highlights a corresponding area of the first electronic document in the first potion of the web interface.

22. A computer program product, encoded on one or more non-transitory computer storage media, comprising instructions that when executed by one or more computers cause the one or more computers to perform operations comprising:
receiving, by an intermediary system between a supplier and a customer, a particular electronic document from the supplier;
identifying, by the intermediary system, a plurality of areas within the first electronic document, each area including text;
computing a feature representing content within a particular area of the plurality of areas;
determining, by the intermediary system and based upon the feature representing content within the particular area, a label for the particular area from a set of labels that describe potential document areas;
generating, by the intermediary system, a draft that associates the determined label with the particular area and text extracted from the particular area; and
providing, by the intermediary system, the draft to the supplier for confirmation.

23. The computer program product of claim 22, wherein the operations further comprise:
receiving, by the intermediary system, corrected text for the particular area;
generating a validated electronic document including associating the corrected text with the particular area; and
providing the validated electronic document to the customer.
